(19) United States
(12) Patent Application Publication
(10) Pub. No.: US 2024/0175696 A1
(43) Pub. Date: May 30, 2024

(54) Systems and Methods for Detecting a Vehicle Type in Order to Adapt Directions and Navigation Instructions

(71) Applicant: Google LLC, Mountain View, CA (US)

(72) Inventor: Matthew Sharifi, Kilchberg (CH)

(21) Appl. No.: 17/792,553

(22) PCT Filed: Jan. 13, 2022
(86) PCT No.: PCT/US2022/012249

§ 371 Date: Jul. 20, 2023

(51) Int. Cl. G01C 21/34

(52) U.S. Cl. CPC G01C 21/3484

(57) ABSTRACT

The present disclosure provides computer-implemented methods, systems, and devices for detecting a vehicle type in order to adapt directions and navigation instructions mitigating noise in a signal. A computing device initiates, in response to user input, a navigation application. The computing device further detects one or more vehicle type identification signals associated with a vehicle. The computing device further automatically determines, using the one or more signals, a vehicle type associated with the vehicle. The computing device further receives from the navigation application, navigation information, wherein the navigation information is customized based on the determined vehicle type.

The present disclosure relates generally to computer-based navigation. More particularly, the present disclosure relates to automatically detecting a vehicle type in order to adapt directions and navigation instructions.

### BACKGROUND

As computer technology has improved, the number and type of services that can be provided to users have increased dramatically. The services provided via computer technology include navigation services. A navigation service can allow a user to navigate from a current position to a destination position. The user can submit a destination (e.g., an address) through an application associated with a navigation service. The navigation service can, using map data for a geographic area, generate a planned route to the destination. In some examples, the planned route includes one or more turn-by-turn navigation directions. The optimal route can differ based on the type of vehicle for which the navigation directions are chosen.

### SUMMARY

Aspects and advantages of embodiments of the present disclosure will be set forth in part in the following description, or can be learned from the description, or can be learned through practice of the embodiments.

One example aspect of the present disclosure is directed to a computing device with one or more processors and a computer-readable memory, wherein the computer-readable memory stores instructions that, when executed by the one or more processors, cause the computing device to perform operations. The operations include initiating, in response to user input, a navigation application. The operations include detecting one or more vehicle type identification signals associated with a vehicle. The operations further include automatically determining, using the one or more signals, a vehicle type associated with the vehicle. The operations further include receiving, from the navigation application, navigation information, wherein the navigation information is customized based on the determined vehicle type.

Another example aspect of the present disclosure is directed towards a computer-implemented method. The computer-implemented method includes initiating, by a computing device with one or more processors, in response to user input, a navigation application. The computer-implemented method further includes detecting, by the computing device, one or more vehicle type identification signals associated with a vehicle. The computer-implemented method further includes automatically determining, by the computing device using the one or more signals, a vehicle type associated with the vehicle. The computer-implemented method further includes receiving, by the computing device, from the navigation application, navigation information, wherein the navigation information is customized based on the determined vehicle type.

Another example aspect of the present disclosure is directed towards a computer-readable medium storing instructions that, when executed by one or more computing devices, cause the one or more computing devices to perform operations. The operations include initiating, in response to user input, a navigation application. The operations include detecting one or more vehicle type identification signals associated with a vehicle. The operations further include automatically determining, using the one or more signals, a vehicle type associated with the vehicle. The operations further include receiving, from the navigation application, navigation information, wherein the navigation information is customized based on the determined vehicle type.

Other aspects of the present disclosure are directed to various systems, apparatuses, non-transitory computer-readable media, user interfaces, and electric devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures, in which:

FIG. 1 depicts an example computing device according to example embodiments of the present disclosure:

FIG. 2 depicts an example server-client system according to example embodiments of the present disclosure:

FIG. 3 depicts an example navigation system according to example embodiments of the present disclosure:

FIG. 4 depict an example user interface according to example embodiments of the present disclosure:

FIG. 5 depicts an example block diagram representing the steps for a method of determining a vehicle type for a current vehicle of a user and customizing navigation information based on the determined vehicle type according to example embodiments of the present disclosure:

FIG. 6. depicts an example block diagram of a vehicle type identification system in accordance with example embodiments of the present disclosure; and

FIG. 7 depicts an example flow diagram for a method of determining a vehicle type and providing customized navigation information according to example embodiments of the present disclosure.

### DETAILED DESCRIPTION

Reference now will be made in detail to embodiments of the present disclosure, one or more examples of which are illustrated in the drawings. Each example is provided by way of explanation of the present disclosure, not limitation of the present disclosure. In fact, it will be apparent to those skilled in the art that various modifications and variations can be made to the present disclosure without departing from the scope or spirit of the disclosure. For instance, features illustrated or described as part of one embodiment can be used with another embodiment to yield a still further embodiment. Thus, it is intended that the present disclosure covers such modifications and variations as come within the scope of the appended claims and their equivalents.

Generally, the present disclosure is directed towards a system for automatically determining a vehicle type associated with a particular vehicle and providing customized navigation information that accounts for the determined vehicle type. For example, a user may use a navigation application to access directions to a particular location and/or information about their location. In some examples, the specific vehicle type of a vehicle that a user is currently riding in or driving can be useful in determining the most useful navigation information that can be provided by the navigation application. To determine the specific vehicle type, the navigation application can (e.g., upon startup, periodically, and/or when a navigational query is submitted) access one or more vehicle type identification signals available to the navigation application. Based on these vehicle type identification signals, the navigation application can automatically determine a vehicle type associated with the current vehicle of the user. In some examples, vehicle types can include an electric vehicle, a motorcycle, a multi-axle truck, two vs. four-wheel drive, low vs. high ground clearance, a vehicle height, and so on. Once the vehicle type is determined, the navigation application can provide navigation information to the user upon request that has automatically been customized based on the vehicle type of the vehicle. For example, the navigation information can include a customized navigational route from an origin to a destination that is optimized for the determined vehicle type (e.g., takes into account certain needs or constraints of the determined vehicle type such as access to refueling or recharging locations, the ability of the vehicle type to handle rough terrain, vehicle type restriction for roads, and so on).

To provide an illustrative example, a user can use a smartphone to access navigation information while driving a truck with more than four axles. In this case, when a navigation application on the smartphone is initiated, the navigation application can, as part of its startup process or at some other point, access one or more vehicle type signals available to it. For example, the navigation application can access an audio sensor associated with the smartphone and monitor the ambient noise in the environment of the smartphone. Based on that ambient noise, the navigation application can automatically determine that the current vehicle has a vehicle type of “multi-axle truck.” Based on this information, the navigation application can respond to navigation requests by identifying routes appropriate for multi-axle trucks. The navigation application can also provide route warnings to any situations which may require special attention for a driver operating a multi-axle truck. Thus, if the user enters a destination and requests navigation directions for that destination, the navigation application can select a route that is optimal for that multi-axle truck.

More generally, a computing device can be or include a portable computing device. A portable computing device can be any computing device that is designed to be portable with a user and is not integrated directly into a vehicle (e.g., not an onboard navigation system). For example, a portable computing device can include, but is not limited to, smartphones, smartwatches, fitness bands, tablet computers, laptop computers, and so on. In some examples, a portable computing device can include one or more sensors intended to gather information with the permission of the user such as audio information or location information. Alternatively, a computing device can be an embedded device that is integrated into a vehicle (e.g., included in an onboard navigation system).

A navigation application can be any application configured to provide navigation information to a user upon request. For example, a navigation application can provide turn-by-turn directions from a starting location to an ending location. A navigation application can also allow a user to search for particular points of interest in a geographic location. For example, a user can submit a query (e.g., using keywords) to the navigation application along with a specific geographic location. In response to the received query, the navigation application can generate a list of one or more candidate points of interest that match both the query and the geographic location. For example, a user can submit a query for “grocery stores” near the user's current location, and a navigation application can respond with a list of candidate matches near the current location of a user. In addition, the navigation application can provide navigation directions to one or more of the candidate locations.

In some examples, the navigation application can receive queries from a user and provide, via a display, navigation directions that respond to the user's query by providing turn-by-turn directions from a first location to a second location specified in the query. In some examples, the navigation application can communicate over a network to a server system that stores map and navigation information. The server system can, in response to the received user query, provide the requested map and/or navigation information to the navigation application for display to the user. In further examples, the navigation application can provide the navigation directions to a vehicle that is semi- or fully autonomous and the vehicle can use the navigation directions to perform semi- or fully autonomous driving operations to follow the navigation directions.

In some examples, the navigation application can, upon startup, periodically, and/or upon receipt of a query, access one or more vehicle type identification signals that can be used to determine the vehicle type of vehicle in which the computing device is currently placed (herein referred to as the current vehicle). For example, a user takes their smartphone into their car and starts up the navigation application. During that start-up process, the navigation application can gather one or more signals that allow the navigation application to automatically determine the vehicle type of the current vehicle in which the user is sitting. These signals can be referred to as vehicle type identification signals.

In some examples, the one or more vehicle type identification signals can include information associated with wireless signals detectable by the computing system. For example, the computing system can detect a signal associated with a Bluetooth device in the area of the computing device. The navigation system can extract information from the Bluetooth signal including a public name of the Bluetooth device, a Bluetooth ID for the device, and/or a MAC address of the Bluetooth device. In some examples, any of these pieces of information can be used by the navigation system to help determine the vehicle type of the current vehicle.

The vehicle type identification signal can be a signal associated with a physically connected device. For example, the computing device can connect to the vehicle via an interface such as Android Auto. Upon request by the navigation system, Android Auto can provide vehicle metadata to the navigation device via an associated API. Vehicle metadata can include, but is not limited to, vehicle type, vehicle make, vehicle model, vehicle dimensions, vehicle capabilities and characteristics, and so on.

The one or more vehicle type notification signals can include the ambient sounds associated with the environment of the vehicle. For example, an audio sensor in the user computing device can capture ambient sound information around it. This ambient sound information can be analyzed to determine one or more factors including, but not limited to, the sound of the engine of the vehicle at rest, the sound of the engine of the vehicle when accelerating or decelerating, the relative volume of noise produced by the engine relative to other sources of background sound, and so on. This audio information can be analyzed (e.g., using a machine learning model) and used as a factor in determining the vehicle type of the current vehicle. For example, no engine noise can be associated with an electric vehicle while very loud engine or low-pitched noise can be associated with a multi-axle truck. In some examples, certain types of braking systems produce identifiable sounds and can be used to determine a vehicle type.

In some examples, once the navigation application has gathered one or more vehicle type identification signals, the navigation application can use those signals to automatically determine a vehicle type associated with the current vehicle. In some examples, each of the one or more vehicle type identification signals can be used to generate feature data representing the information gathered from the signals. In some examples, the feature data can be generated such that each feature is a value between 0 and 1. In some examples, each signal can be used to generate a plurality of feature values, each feature value representing a particular aspect of the signal.

The generated feature data can be used as input to an algorithm or machine-learned model (e.g., neural network, decision tree, etc.). Based on the input and feature data, the algorithm or machine learned model can output a determined vehicle type for the current vehicle. As one example, a machine learning model (e.g., a neural network) can be trained to receive and process the input feature data to generate a classification of the vehicle into one of a number of different vehicle types/classes. In some examples, the vehicle type output can have an associated confidence value that represents the likelihood that the output vehicle type is the correct vehicle type for the current vehicle.

In some examples, one or more vehicle profiles can be stored in the user profile. Each vehicle profile can be associated with a particular vehicle that is associated with the user. For example, a particular vehicle profile can include data that describes one vehicle that the user owns, commonly drives, has previously ridden in, and so on. A vehicle profile can store information about the vehicle including its make, model, size and dimensions, specifications, noise profile, and the times in which the user commonly uses the corresponding vehicle. In addition, a vehicle profile can include a vehicle type.

In some examples, the navigation application can determine a vehicle type for the current vehicle by comparing it to one or more vehicle profiles included in the user profile. For example, the navigation application can receive the output of the algorithm or machine learning model that indicates one or more potential vehicle types. The potential vehicle types, and corresponding confidence values, can be compared to the one or more vehicles represented by one or more vehicle profiles stored in the user profile. Other information, including the location of the user computing device and/or so the current day or time can be used to determine the specific vehicle profile associated with the current vehicle.

In some examples, the navigation application can prompt the user to confirm the vehicle type of their current vehicle. For example, if the navigation application determines that the current vehicle is an electric vehicle, the computing device can display a prompt requesting that the user confirm that the current vehicle is an electric vehicle. In some examples, if a specific vehicle profile is identified as the current vehicle, the user can be prompted to confirm that the selected vehicle profile matches the current vehicle. If the user confirms the determined vehicle profile is the current vehicle, the confidence associated with that confirmation can be very high (e.g., 100 percent confident).

In some examples, the navigation application can prompt the user to supply the vehicle type information for the current vehicle. For example, a prompt can be presented asking the user “Is your current vehicle an electric vehicle?” and the user can select one of a plurality of presented vehicle types. Additionally, or alternatively, the navigation application can prompt the user to supply additional detail. For example, if the navigation application determines a make (or brand) of a vehicle based on a Bluetooth signal ID, the navigation application can prompt the user to supply the specific model of the current vehicle.

Once the vehicle type has been determined for the current vehicle, the navigation application can use that vehicle type to customize navigation information provided to the user. For example, a user can request navigation directions to a particular destination. The navigation application can generate a plurality of possible routes from the current location to the destination and select routes that are optimized for the particular vehicle type. For example, electric vehicles may prefer to travel a shorter distance even if the amount of travel time is longer whereas a gas-powered (petrol or diesel) vehicle may prefer the shorter time rather than the shorter distance. Similarly, some vehicles, like multi-axle trucks, are not allowed, by law; on particular roads. The navigation application can eliminate routes in which the vehicle type is not allowed.

In some examples, the navigation application can provide en-route warnings to the user for their vehicle based on the determined vehicle type. For example, if a particular road has a sharp turn that can be difficult to navigate when the vehicle is a camper van or a truck with a trailer, the navigation application can provide a warning to the user before the sharp turn. In another example, an electrical charging station associated with an electric vehicle can be out of service and as a result the navigation application can provide a warning that the user may want to select a different route option or take a slight detour to reach a charging station. In another example, the navigation application can provide a warning of a low bridge or other obstacle based on the height of the vehicle type.

The navigation application can automatically customize a user's query information by including information about the vehicle type. For example, the user can enter a query for service stations. Prior to sending the query to a server, the navigation application can customize it by appending information associated with the determined vehicle type. In this way, the response from the server system can also be customized to be as applicable as possible to the vehicle type. For example, if the vehicle type is an electric vehicle, only service stations associated with electric vehicles will be returned as potential search results for display to the user.

The systems and methods of the present disclosure provide a number of technical effects and benefits. As one example, the proposed systems can provide for automatically detecting a vehicle type for a vehicle of a user. Automatically detecting the vehicle type associated with a vehicle enables a navigation application to provide more efficient routing and responses to queries (e.g., by providing a route that is most fuel effective for the determined vehicle type). Improving the effectiveness of navigation applications can reduce the amount of storage needed together with the associated resources used when providing navigation information and can reduce the amount of re-navigation required which in-turn can reduce the computing device processor usage as well as associated network and resource overhead. Reducing the amount of storage needed and resource usage reduces the cost of the navigation service associated with the navigation application and improves the user experience. This represents an improvement in the functioning of the device itself.

With reference now to the Figures, example embodiments of the present disclosure will be discussed in further detail.

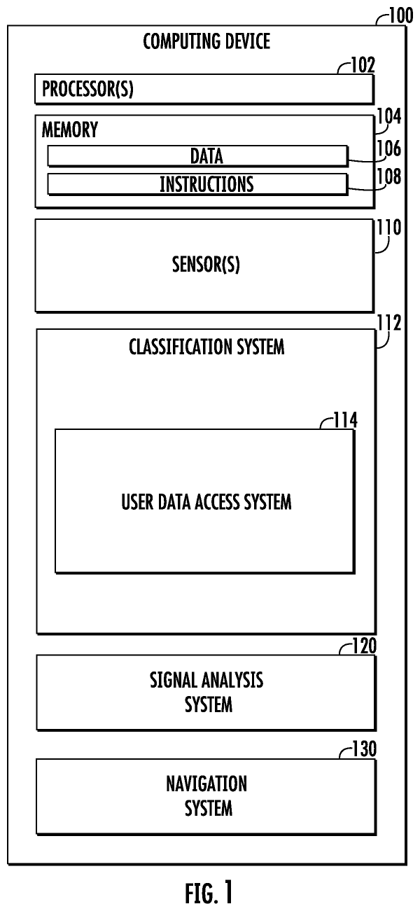

FIG. 1 depicts an example computing device 100 according to example embodiments of the present disclosure. In some example embodiments, the computing device 100 can be any suitable device, including, but not limited to, a smartphone, a tablet, a laptop, a desktop computer, a global positioning system (GPS) device, a computing device integrated into a vehicle, or any other computing device that is configured such that it can allow a person to execute a navigation application or access a navigation service at a server computing system. The computing device 100 can include one or more processor(s) 102, memory 104, one or more sensors 110, a classification system 112, a signal analysis system 120, and a navigation system 130.

The one or more processor(s) 102 can be any suitable processing device, such as a microprocessor, microcontroller, integrated circuit, or other suitable processing device. The memory 104 can include any suitable computing system or media, including, but not limited to, non-transitory computer-readable media, RAM, ROM, hard drives, flash drives, or other memory devices. The memory 104 can store information accessible by the one or more processor(s) 102, including instructions that can be executed by the one or more processor(s) 102. The instructions can be any set of instructions that when executed by the one or more processor(s) 102, cause the one or more processor(s) 102 to provide the desired functionality.

In particular, in some devices, memory 104 can store instructions for implementing the classification system 112, the signal analysis system 120, and the navigation system 130. The computing device 102 can implement the classification system 112, the signal analysis system 120, and the navigation system 130 to execute aspects of the present disclosure, including determining a vehicle type for a current vehicle and providing navigation services (e.g., turn-by-turn directions, location-based searching, and so on) to a user.

It will be appreciated that the terms “system” or “engine” can refer to specialized hardware, computer logic that executes on a more general processor, or some combination thereof. Thus, a system or engine can be implemented in hardware, application specific circuits, firmware, and/or software controlling a general-purpose processor. In one embodiment, the systems can be implemented as program code files stored on a storage device, loaded into memory and executed by a processor or can be provided from computer program products, for example computer executable instructions, that are stored in a tangible computer-readable storage medium such as RAM, hard disk, or optical or magnetic media.

Memory 104 can also include data 106, such as map data associated with the navigation system 130 (e.g., data representing a geographic area including one or more roads and a one or locations of interest received from a server system), that can be retrieved, manipulated, created, or stored by the one or more processor(s) 102. In some example embodiments, such data can be accessed and displayed to a user of the computing device 100 (e.g., during use of a navigation system 130) or transmitted to a server computing system as needed.

In some example embodiments, the computing device 100 includes a classification system 112, a signal analysis system 120, and a navigation system 130. The signal analysis system 120 and the classification system 112 can act to support the navigation system 130 by automatically determining a vehicle type for which the navigation system 130 is providing navigation information.

For example, in response to the navigation system 130 determining that the navigation services are being accessed (e.g., upon initiation of the navigation system 130, periodically while the navigation system 130 is running, and/or upon the user submitting a request or query to the navigation system 130), the signal analysis system 120 (e.g., in response to a request from the navigation system 130) can access one or more vehicle type identification signals that can be used to determine the vehicle type of vehicle for which navigation services are being accessed (e.g., the vehicle in which the computing device is physically located). For example, a user can bring a smartphone into their car and start up a navigation application (e.g., navigation system 130). During that start-up process, the signal analysis system 120 can gather one and more signals to automatically determine the vehicle type of the current vehicle in which the user is sitting. These signals can be referred to as vehicle type identification signals.

In some examples, the one or more vehicle type identification signals can include information associated with wireless signals detectable by the computing device 100. For example, the signal analysis system 120 can detect a signal associated with a Bluetooth device in the area of the computing device 100. The signal analysis system 120 can extract information from the Bluetooth signal including a public name of the Bluetooth device, a Bluetooth ID for the device, and/or a MAC address of the Bluetooth device. In some examples, any of these pieces of information can be processed by signal analysis system 120 to generate data that can help determine the vehicle type of the current vehicle.

In some examples, the vehicle type identification signal is a signal associated with a physically connected device. For example, the computing device 100 can connect to the vehicle via an interface such as Android Auto. Upon request by the signal analysis system 120 or a component of the navigation system 130, Android Auto can provide vehicle metadata to the navigation device via an associated API. Vehicle metadata can include, but is not limited to, vehicle type, vehicle make, vehicle model, vehicle dimensions, and so on.

In some examples, the one or more vehicle type notification signals can include the ambient sounds associated with the environment of the vehicle. For example, the signal analysis system 120 can receive output from an audio sensor 110 in the computing device. The output data from the audio sensor 110 can include information from captured ambient sound information in the area of the computing device 100. This ambient sound information can be analyzed to determine one or more factors including, but not limited to, the sound of the engine of the vehicle at rest, the sound of the engine of the vehicle when accelerating or decelerating, the relative volume of noise produced by the engine relative to other sources of background sound, and so on. This audio information can be analyzed (e.g., using a machine learning model) and used as a factor in determining the vehicle type of the current vehicle. For example, no engine noise can be associated with an electric vehicle while very loud and/or low-pitched engine noise can be associated with a multi-axle truck. In some examples, certain types of braking systems produce identifiable sounds and can be used to determine a vehicle type.

The signal analysis system 120 can transmit data generated based on one or more detected signals to the classification system 112. The classification system 112 can use those signals to automatically determine a vehicle type associated with the current vehicle. In some examples, each of the one or more vehicle type identification signals can be used to generate feature data representing the information gathered from the vehicle type identification signals. In some examples, the feature data can be generated such that each feature is normalized to a value between 0 and 1. In some examples, each signal can be used to generate a plurality of feature values, each feature value representing a particular aspect of the signal. In some examples, the feature values can be weighted based on importance.

The generated feature data can be used as input to an algorithm or machine-learned model (e.g., neural network, decision tree, etc.). Based on the input and feature data, the algorithm or machine-learned model can output a determined vehicle type for the current vehicle. As one example, a machine learning model (e.g., neural network) can be trained to receive and process the input feature data to generate a classification of the vehicle into one of a number of different vehicle types/classes. In some examples, the vehicle type output can have an associated confidence value that represents the likelihood that the output vehicle type is the correct vehicle type for the current vehicle.

In some examples, the classification system 112 can include a user data access system 114. The user data access system 114 can access data about the user. For example, the data about the user can include a user profile for the user. In some examples, one or more vehicle profiles can be stored in a user profile. Each vehicle profile can be associated with a particular vehicle that is associated with the user. For example, a particular vehicle profile can include data that describes one vehicle that the user owns, commonly drives, has previously ridden in, and so on. A vehicle profile can store information about the vehicle including its make, model, size and dimensions, specifications, noise profile, and the times in which the user commonly uses the corresponding vehicle. In addition, the vehicle profile can include a vehicle type.

In some examples, the classification system 112 can determine a vehicle type for the current vehicle by comparing it to one or more vehicle profiles included in the user profile retrieved by the user data access system 114. For example, the classification system 112 can receive the output of the algorithm or machine learning model that indicates one or more potential vehicle types. The potential vehicle types, and corresponding confidence values, can be compared to the one or more vehicles represented by one or more vehicle profiles stored in the user profile. Other information, including the location of the user computing device and/or so the current day or time can be used to determine the specific vehicle profile associated with the current vehicle.

In some examples, the navigation system 130 can prompt the user to confirm the vehicle type of their current vehicle. For example, if the classification system 112 determines that the current vehicle is an electric vehicle and transmits that determination to the navigation system 130, the navigation system 130 can cause the computing device 100 to display a prompt requesting that the user confirm that the current vehicle is an electric vehicle. In some examples, if a specific vehicle profile is identified as the current vehicle, the user can be prompted to confirm that the selected vehicle profile matches the current vehicle. If the user confirms the determined vehicle profile is the current vehicle, the confidence associated with that confirmation can be very high (e.g., 100 percent confident).

The navigation system 130 can provide, in a display, a visual depiction of a geographic area. The visual depiction of the geographic area can include one or more streets, one or more points of interest (including buildings, landmarks, and so on), and a highlighted depiction of a planned route. In some examples, the navigation application 130 can also provide location-based search options to identify one or more searchable points of interest within a given geographic area. In some examples, the navigation system 130 can include a local copy of the relevant map data. In other examples, the navigation system 130 can access information at a remote server computing system to provide the requested navigation services.

In some examples, the navigation system 130 can be a dedicated application specifically designed to provide navigation services. In other examples, the navigation system 130 can be enabled by a general application (e.g., a web browser) that can provide access to a variety of different services including a navigation service via a network.

Once the vehicle type has been determined for the current vehicle, the navigation system 130 can use that vehicle type to customize navigation information provided to the user. For example, a user can request navigation directions to a particular destination. The navigation system 130 can generate a plurality of possible routes from the current location to the destination and select routes that are optimized for the particular vehicle type. For example, electric vehicles may prefer to travel a shorter distance even if the amount of travel time is longer whereas a gas-powered vehicle may prefer the shorter time rather than the shorter distance. Similarly, some vehicles, like multi-axle trucks, are not allowed, by law, on particular roads. The navigation system 130 can eliminate routes in which the vehicle type is not allowed.

In some examples, the navigation system 130 can provide en-route warnings to the user for their vehicle based on the determined vehicle type. For example, if a particular road has a sharp turn that can be difficult to navigate when the vehicle is a camper van or a truck with a trailer, the navigation system 130 can provide a warning to the user before the sharp turn. In another example, an electrical charging station associated with an electric vehicle can be out of service and, as a result, the navigation system 130 can provide a warning that the user may want to select a different route option or take a slight detour to reach a charging station. In another example, the navigation system 130 can provide a warning of a low bridge or other obstacle based on the height of the vehicle type.

In some examples, the navigation system 130 can automatically customize a user's query information by including information about the vehicle type. For example, the user can enter a query for service stations. Prior to sending the query to a server, navigation system 130 can customize it by appending information associated with the determined vehicle type. In this way, the response from the server system can also be customized to be as applicable as possible to the vehicle type. For example, if the vehicle type is an electric vehicle, only service stations associated with electric vehicles will be returned as potential search results for display to the user by the navigation system 130.

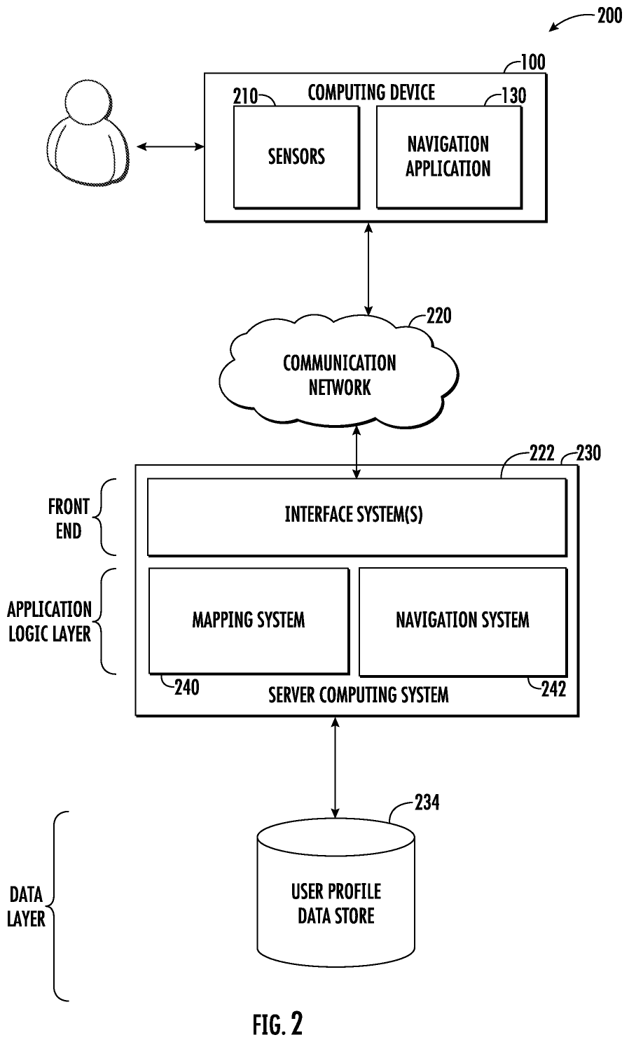

FIG. 2 depicts an example client-server environment 200 according to example embodiments of the present disclosure. The client-server system environment 200 includes one or more user computing devices 100 and a server computing system 230. One or more communication networks 220 can interconnect these components. The communication networks 220 may be any of a variety of network types, including local area networks (LANs), wide area networks (WANs), wireless networks, wired networks, the Internet, personal area networks (PANs), or a combination of such networks.

A user computing device 100 can include, but is not limited to, smartphones, smartwatches, fitness bands, navigation computing devices, laptops computers, embedded computing devices (computing devices integrated into other objects such as clothing, vehicles, or other objects). In some examples, a user computing device 100 can include one or more sensors intended to gather information with the permission of the user associated with the user computing device 100.

In some examples, the user computing device 100 can connect to another computing device, such as a personal computer (PC), a laptop, a smartphone, a tablet, a mobile phone, an electrical component of a vehicle, or any other electric device capable of communication with the communication network 220. A user computing device 100 can include one or more application(s) such as search applications, communication applications, navigation applications 130, productivity applications, game applications, word processing applications, or any other applications. The application(s) can include a web browser. The user computing device 100 can use a web browser (or other application) to send and receive requests to and from the server computing system 230. The application(s) can include a navigation application 130 that enables the user to send navigation requests to the server computing system 230 and receive navigation information in response.

In some examples, the user computing device 100 can include one or more sensors 210 that can be used to determine information, with the express permission of the user, associated with the environment of the user computing device 100 or information associated with the user of the user computing device 100 (such as the position or movement of the user). In some examples, the sensors 210 can include a motion sensor to detect movement of the device or the associated user, a location sensor (e.g., a GPS) to determine the current location of the user computing device 100, an audio sensor to determine the loudness of sounds in the area of the user computing device 100.

As shown in FIG. 2, the server computing system 230 can generally be based on a three-tiered architecture, consisting of a front-end layer, application logic layer, and data layer. As is understood by skilled artisans in the relevant computer and Internet-related arts, each component shown in FIG. 2 can represent a set of executable software instructions and the corresponding hardware (e.g., memory and processor) for executing the instructions. To avoid unnecessary detail, various components and engines that are not germane to conveying an understanding of the various examples have been omitted from FIG. 2. However, a skilled artisan will readily recognize that various additional components and engines may be used with a server computing system 230, such as that illustrated in FIG. 2, to facilitate additional functionality that is not specifically described herein. Furthermore, the various components depicted in FIG. 2 may reside on a single server computer or may be distributed across several server computers in various arrangements. Moreover, although the server computing system 230 is depicted in FIG. 2 as having a three-tiered architecture, the various example embodiments are by no means limited to this architecture.

As shown in FIG. 2, the front end can consist of an interface system(s) 222, which receives communications from one or more user computing devices 100 and communicates appropriate responses to the user computing devices 100. For example, the interface system(s) 222 may receive requests in the form of Hypertext Transfer Protocol (HTTP) requests, or other web-based, application programming interface (API) requests. The user computing devices 100 may be executing conventional web browser applications or applications that have been developed for a specific platform to include any of a wide variety of computing devices and operating systems.

As shown in FIG. 2, the data layer can include a user profile data store 234. The user profile data store 234 can include a plurality of user profiles, each user profile containing data associated with a particular user. In some examples, a user profile can include demographic data supplied by the user about themselves, a user ID, information describing a user's interests, likes, and habits, one or more vehicle profiles associated with the user, and so on.

Each vehicle profile can include information about a specific vehicle associated with the user including the make, model, specifications, capabilities, and dimensions of the vehicle. The vehicle profile for a specific vehicle can also include information about past uses of the vehicles including, but not limited to, locations where the vehicle is used, times in which the vehicle is used, information about the length of trips, information describing whether the user is generally a passenger or a driver in the vehicle, and so on. In addition, a vehicle profile can include information about signals detectable within the vehicle including but not limited to wireless signal identifiers commonly sensed within the vehicle, information available via an API within the vehicle (e.g., Android Auto data), sound information associated with the vehicle, and motion information associated with the vehicle.

The application logic layer can include application data that can provide a broad range of other applications and services that allow users to access or receive geographic data for navigation or other purposes. The application logic layer can include a mapping system 240 and a navigation system 242.

The mapping system 240 can, in response to queries received from one or more users, identify one or more search results, the search results being associated with particular geographic locations. For example, a user computing device 100 can submit a search query for “grocery stores” along with a geographic location. The mapping system 240 can generate a list of search results that match the query terms near the geographic location. The search results can be ranked or ordered based on the quality of the match between the search terms and the results, the distance from the geographic location and the location associated with the search result, or a combination of both.

In some examples, the search query can include information describing a particular vehicle type that is associated with the query. For example, the user computing device can determine a vehicle type of the current vehicle of the user automatically and supply that with the received search query. The vehicle type can then be used by the mapping system 240 when generating or ranking search results. For example, if the vehicle type that is supplied with a query is a multi-axle truck, the mapping system 240 can ignore potential results that are associated with roads on which multi-axle trucks are banned. In this way, the mapping system 240 can customize results based on vehicle type data received with a particular query.

A navigation system 242 can provide, for display, data enabling a visual depiction of a geographic area. The visual depiction of the geographic area can include one or more streets, one or more points of interest (including buildings, landmarks, and so on), and a highlighted depiction of a planned route. The navigation system 242 can receive, via the interface, a navigation request query including an initial location and a final location. The navigation system 242 can generate a navigation route from the initial location to the final location.

In some examples, if no vehicle type is provided with the query, the navigation system 242 can prompt the user to select a particular vehicle type. In other examples, the navigation system 242 can transmit data to the user computing device 100 displaying one or more vehicle profiles associated with the user (from the user profile data store 234). The user can be prompted to select the vehicle profile associated with the received query.

In some examples, a navigation request query can include a vehicle type for the vehicle which will be used to travel the requested route. The navigation system 242 can use that vehicle type to customize navigation information provided to the user. For example, a user can request navigation directions to a particular destination. The navigation system 242 can generate a plurality of possible routes from the current location to the destination and select routes that are optimized for the particular vehicle type. For example, electric vehicles may prefer to travel a shorter distance even if the amount of travel time is longer whereas a gas-powered vehicle may prefer the shorter time rather than the shorter distance. Similarly, some vehicles, like multi-axle trucks, are not allowed, by law, on particular roads. The navigation system 242 can eliminate routes in which the vehicle type is not allowed.

In some examples, the navigation system 242 can provide en-route warnings to the user for their vehicle based on the determined vehicle type. For example, if a particular road has a sharp turn that can be difficult to navigate when the vehicle is a camper van or a truck with a trailer, the navigation system 242 can provide, as part of the generated turn-by-turn directions, a warning to the user before the sharp turn. In another example, an electrical charging station associated with an electric vehicle can be out of service and, as a result, the navigation system 242 can provide a warning that the user may want to select a different route option or take a slight detour to reach a charging station. In another example, the navigation system 242 can provide a warning of a low bridge or other obstacle based on the height of the vehicle type.

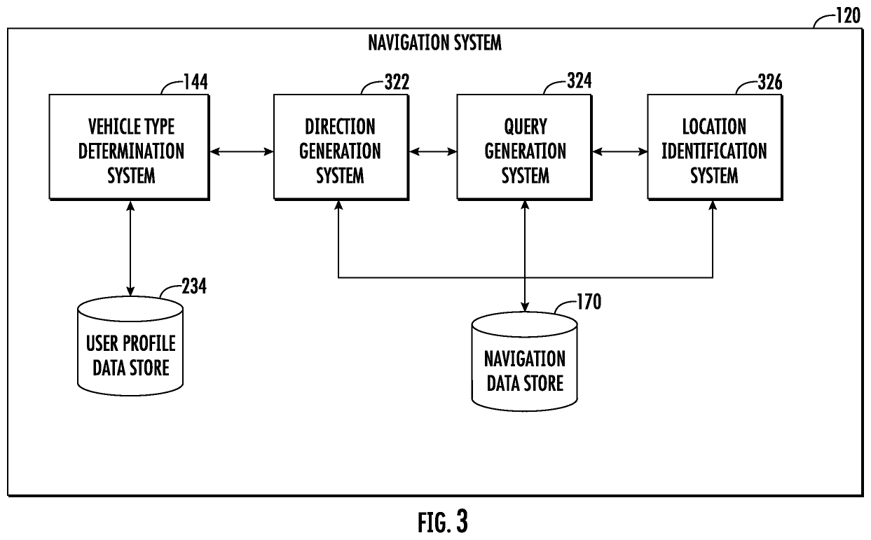

FIG. 3 illustrates an example navigation system 130 in accordance with example embodiments of the present disclosure. The navigation system 130 can include a vehicle type determination system 144, a direction generation system 302, a query generation system 304, and a location identification system 306.

For example, a vehicle type determination system 144 can determine a vehicle type for a current vehicle by gathering data from one or more signals. For example, the vehicle type determination system 144 can access one or more vehicle type identification signals that can be used to determine the vehicle type of vehicle in which the computing device is currently placed. For example, a user takes their smartphone into their car and starts up the vehicle type determination system 144. During that start-up process, the vehicle type determination system 144 can gather one and more signals that allow a navigation system 120 to automatically determine the vehicle type of the current vehicle in which the user is sitting. These signals can be referred to as vehicle type identification signals.

In some examples, the vehicle type identification signal is a signal associated with a physically connected device. In some examples, the one or more vehicle type notification signals can include the ambient sounds associated with the environment of the vehicle.

In some examples, once the vehicle type determination system 144 has gathered one or more vehicle type identification signals, the vehicle type determination system 144 can use those signals to automatically determine a vehicle type associated with the current vehicle. In some examples, each of the one or more vehicle type identification signals can be used to generate feature data representing the information gathered from the signals. In some examples, the feature data can be generated such that each feature is a value between 0 and 1. In some examples, each signal can be used to generate a plurality of feature values, each feature value representing a particular aspect of the signal.

The generated feature data can be used as input to an algorithm or machine-learned model (e.g., neural network, decision tree, etc.). Based on the input and feature data, the algorithm or machine-learned model can output a determined vehicle type for the current vehicle. As one example, a machine learning model (e.g., neural network) can be trained to receive and process the input feature data to generate a classification of the vehicle into one of a number of different vehicle types/classes. In some examples, the vehicle type output can have an associated confidence value that represents the likelihood that the output vehicle type is the correct vehicle type for the current vehicle.

In some examples, one or more vehicle profiles can be stored in the user data profile store 234. Each vehicle profile can be associated with a particular vehicle that is associated with the user. For example, a particular vehicle profile can include data that describes one vehicle that the user owns, commonly drives, has previously ridden in, and so on. A vehicle profile can store information about the vehicle including its make, model, size and dimensions, specifications, noise profile, and the times in which the user commonly uses the corresponding vehicle. In addition, the vehicle profile can include a vehicle type.

In some examples, the vehicle type determination system 144 can determine a vehicle type for the current vehicle by comparing it to one or more vehicle profiles included in the user profile. For example, the navigation application can receive the output of the algorithm or machine learning model that indicates one or more potential vehicle types. The potential vehicle types, and corresponding confidence values, can be compared to the one or more vehicles represented by one or more vehicle profiles stored in the user profile. Other information, including the location of the user computing device and/or so the current day or time can be used to determine the specific vehicle profile associated with the current vehicle.

The direction generation system 322 can provide directions to a specific location. For example, a user can input a destination location (e.g., an address). In response, the navigation application 120 can, using locally stored map data for a specific geographic area, provide navigation information allowing the user to navigate to the destination location. The navigation information can include turn-by-turn directions from a current location (or a provided location) to the destination location. The direction generation system 322 can select from a plurality of possible routes from the current location to the destination location based on one or more criteria. In some examples, the direction generation system 322 can select a route from a plurality of possible routes based on a vehicle type determined by the vehicle type determination system.

The query generation system 324 can generate queries based on input from the user. In some examples, the query generation system 324 can automatically customize the query based on information determined about the user, the query, and/or the current vehicle of the user. For example, if the vehicle type of the current vehicle is known, the query generation system 324 can modify or customize the query to represent the vehicle type of the current vehicle.

The location identification system 326 can determine a current location for a navigation system 120. It can do so based on location information generated by sensors included in a computing device (e.g., computing device 100 in FIG. 1). In some examples, a global positioning system (GPS) can provide the location information.

In some example embodiments, the navigation data store 170 can store a variety of navigation data. For example, the navigation data store 170 can include map data. In some examples, the map data can include a series of sub-maps, each sub-map including data for a geographic area including objects (e.g., buildings or other static features), paths of travel (e.g., roads, highways, public transportation lines, walking paths, and so on), and other features of interest. The navigation data store 170 can also include image data, the image data associated with one or more geographic areas. The navigation data store can also include satellite image data associated with one or more geographic areas.

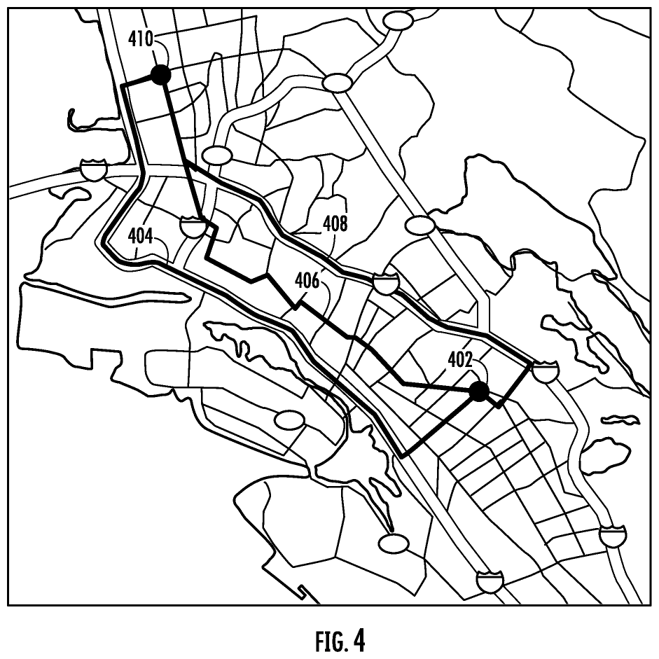

FIG. 4 depicts an example user interface according to example embodiments of the present disclosure. In this example, a user has requested directions from a first point 402 to a second point 410. The navigation system 130 can identify three potential routes (404, 406, and 408). The navigation system 130 can determine which of the potential routes to select or suggest at least in part based on the vehicle type associated with the current vehicle of the user.

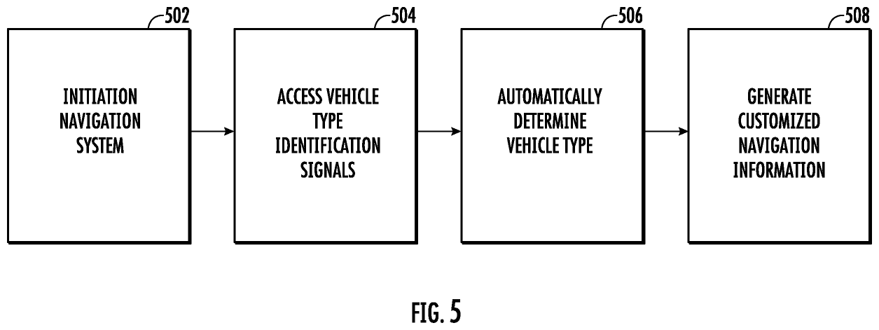

FIG. 5 depicts an example block diagram representing the steps for a method of determining a vehicle type for a current vehicle of a user and customizing navigation information based on the determined vehicle type according to example embodiments of the present disclosure.

In some examples, a user, at 502, initiates a navigation application. For example, a user can initiate a navigation application on their smartphone. The user can then submit queries through the navigation application for navigation information. In response to initiation of the navigation application or receipt of a query, the navigation application can access, at 504, vehicle type identification signals. In some examples, the navigation application can access vehicle type identification signals based on a periodic schedule.

Based on the vehicle type identification signals, the navigation application can, at 506, automatically determine a vehicle type associated with the current vehicle. Based on the determined vehicle type, the navigation application can, at 508, provide customized navigation including, but not limited to, turn-by-turn directions customized for a particular vehicle, location-based search results filtered or ordered based, at least in part, on the vehicle type of a current vehicle, and so on.

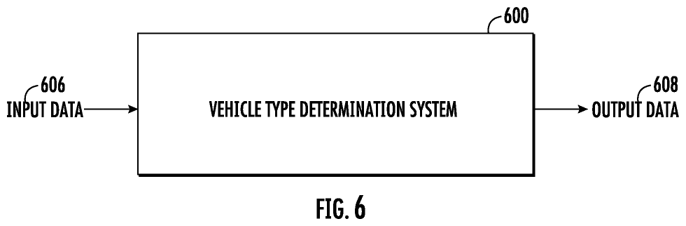

FIG. 6 depicts a block diagram of an example vehicle type generation system 600 according to example embodiments of the present disclosure. In this example, the vehicle type generation system 600 can take, as input 606, feature data generated based on one or more vehicle type determination signals. These signals can include data from wireless signals available in the area of a user computing device, metadata available from the vehicle itself through a provided API, data from audio sensors included in the user computing device, and data from a motion detector. This data can be collected when a navigation application is running on the user computing device with the permission of the users and stored for analysis. The feature data can be normalized and used as input to the vehicle type generation system 600.

In some examples, the vehicle type generation system 600 can employ an algorithm or machine-learned model that users feature data to generate an inference or classification indicating a particular vehicle type. In some examples, the machine-learned model can include various machine-learned models such as neural networks (e.g., deep neural networks), other types of machine-learned models, including non-linear models and/or linear models, or binary classifiers. Neural networks can include feed-forward neural networks, recurrent neural networks (e.g., long short-term memory recurrent neural networks), convolutional neural networks, or other forms of neural networks.

Although the vehicle type generation system 600 can be described as using particular techniques above, either model can be trained based on training data using various other training or learning techniques, such as, for example, backward propagation of errors. For example, a loss function can be backpropagated through the model(s) to update one or more parameters of the model(s) (e.g., based on a gradient of the loss function). Various loss functions can be used such as mean squared error, likelihood loss, cross entropy loss, hinge loss, and/or various other loss functions. Gradient descent techniques can be used to iteratively update the parameters over several training iterations. In some implementations, performing backward propagation of errors can include performing truncated backpropagation through time. Generalization techniques (e.g., weight decays, dropouts, etc.) can be performed to improve the generalization capability of the models being trained.

The vehicle type generation system 600 can generate output 608. The output can indicate a particular vehicle type associated with the current vehicle of the user computing device. In some examples, the vehicle type can also include a confidence value indicating the likelihood that the vehicle type generated by the vehicle type generation system 600 is accurate.

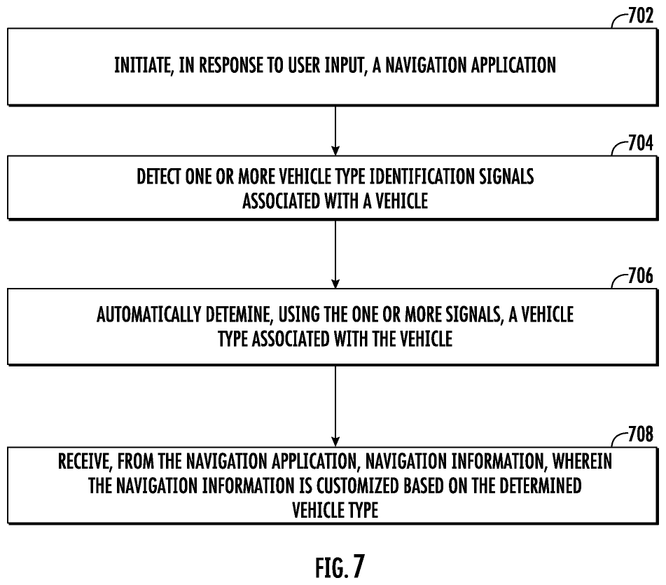

FIG. 7 depicts an example flow diagram for a method of determining a vehicle type and providing customized navigation information according to example embodiments of the present disclosure. One or more portion(s) of the method can be implemented by one or more computing devices such as, for example, the computing devices described herein. Moreover, one or more portion(s) of the method can be implemented as an algorithm on the hardware components of the device(s) described herein. FIG. 7 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, and/or modified in various ways without deviating from the scope of the present disclosure. The method can be implemented by one or more computing devices, such as one or more of the computing devices depicted in FIGS. 1-3.

A computing device (e.g., computing device 100 in FIG. 1) can include one or more processors, memory, and other components that, together, enable the computing device to determine a vehicle type for a particular vehicle and provide personalized navigation information. In some examples, the computing device is a portable computing device, such as a smartphone or tablet computer.

The computing device can initiate a navigation application in response to user input. For example, a user can select a navigation application via a touch input on a smartphone, causing the application to launch. Once the application is initiated, at 702, the user can submit requests for directions or search queries for a given location.

The computing device can detect, at 704, one or more vehicle type identification signals associated with a vehicle. For example, the vehicle type identification signals can be signals accessible from the cabin of a vehicle in which a user is riding or driving. In some examples, one or more vehicle type identification signals associated with the vehicle include wireless communication signals associated with the vehicle or one or more devices within the vehicle. The wireless communication signals can include Bluetooth identification data.

In some examples, the one or more vehicle type identification signals associated with the vehicle include a vehicle identification code provided by the vehicle. The vehicle identification code can be provided via an API associated with the vehicle that can provide metadata about the vehicle.

In some examples, the computing device further comprises an audio sensor and the one or more vehicle type identification signals include ambient sound data collected by the audio sensor. In some examples, the computing device further comprises a movement sensor. In some examples, the one or more vehicle identification signals include the movement data associated with the movement of the vehicle.

The computing device can automatically determine, at 706, using the one or more signals, a vehicle type associated with the vehicle. In some examples, the computing device can store (or access via a network) one or more vehicle profiles, each vehicle profile including data describing a particular vehicle including a vehicle type for the associated vehicle. Thus, automatically determining a vehicle type associated with the vehicle can include matching, by the computing device, the vehicle type identification signals with a vehicle profile in the one or more vehicle profiles. In some examples, the computing device can determine a vehicle type associated with the vehicle based on data stored in the matching vehicle profile. In some examples, the vehicle type can be an electric vehicle. In some examples, the vehicle type can be a multi-axle truck.

The user computing device can receive, from the navigation application, navigation information, wherein the navigation information is customized based on the determined vehicle type. In some examples, the navigation information can include route information from a starting location to an ending location. The navigation information can include one or more navigation warnings for the vehicle based on a current route and the vehicle type.

In some examples, the user computing device can receive a query based on input from the user. The user computing device can modify the query to include vehicle type information. The user computing device can submit the modified query using the navigation application. The user computing device can receive navigation information in response to the modified query.

The technology discussed herein refers to sensors and other computer-based systems, as well as actions taken, and information sent to and from such systems. One of ordinary skill in the art will recognize that the inherent flexibility of computer-based systems allows for a great variety of possible configurations, combinations, and divisions of tasks and functionality between and among components. For instance, server processes discussed herein may be implemented using a single server or multiple servers working in combination. Databases and applications may be implemented on a single system or distributed across multiple systems. Distributed components may operate sequentially or in parallel.

While the present subject matter has been described in detail with respect to specific example embodiments thereof, it will be appreciated that those skilled in the art, upon attaining an understanding of the foregoing may readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art.

The technology discussed herein makes reference to servers, databases, software applications, and other computer-based systems, as well as actions taken, and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

1. A computing device, the computing device comprising:
one or more processors; and
a computer-readable memory, wherein the computer-readable memory stores instructions that, when executed by the one or more processors, cause the computing device to perform operations, the operations comprising:
initiating, in response to user input, a navigation application;
detecting one or more vehicle type identification signals associated with a vehicle;
automatically determining, using the one or more signals, a vehicle type associated with the vehicle; and
receiving, from the navigation application, navigation information, wherein the navigation information is customized based on the determined vehicle type.

2. The computing device of claim 1, wherein one or more vehicle type identification signals associated with the vehicle include wireless communication signals associated with the vehicle or one or more devices within the vehicle.

3. The computing device of claim 2, wherein the wireless communication signals include Bluetooth identification data.

4. The computing device of claim 1, wherein the one or more vehicle type identification signals associated with the vehicle include a vehicle identification code provided by the vehicle.

5. The computing device of claim 1, wherein the computing device further comprises an audio sensor and the one or more vehicle type identification signals include ambient sound data collected by the audio sensor.

6. The computing device of claim 1, wherein the computing device further comprises a motion sensor and the one or more vehicle identification signals include motion data associated with movement of the vehicle.

7. The computing device of claim 1, wherein the operations further comprise:
storing one or more vehicle profiles, each vehicle profile including data describing a particular vehicle including a vehicle type for the associated vehicle; and
wherein automatically determining, by the computing device using the one or more signals, a vehicle type associated with the vehicle further comprises:
matching, by the computing device, the vehicle type identification signals with a vehicle profile in the one or more vehicle profiles; and
determining, by the computing device, a vehicle type associated with the vehicle based on data stored in the matching vehicle profile.

8. The computing device of claim 1, wherein navigation information includes route information from a starting location to an ending location.

9. The computing device of claim 1, wherein navigation information includes one or more navigation warnings for the vehicle based on a current route and the vehicle type.

10. The computing device of claim 1, wherein receiving, by the computing device, from the navigation application, navigation information, wherein the navigation information is customized based on the determined vehicle type:
receiving, by the computing device, a query based on input from the user;
modifying, by the computing device, the query to include vehicle type information;
submitting, by the computing device, the modified query using the navigation application; and
receiving, by the computing device, navigation information in response to the modified query.

11. The computing device of claim 1, wherein the computing device is a portable computing device.

12. The computing device of claim 1, wherein the vehicle type comprises an electric vehicle.

13. The computing device of claim 1, wherein the vehicle type comprises a multi-axle truck.

14. A computer implemented method comprising:
initiating, by a computing device with one or more processors, in response to user input, a navigation application;
detecting, by the computing device, one or more vehicle type identification signals associated with a vehicle;
automatically determining, by the computing device using the one or more signals, a vehicle type associated with the vehicle; and
receiving, by the computing device, from the navigation application, navigation information, wherein the navigation information is customized based on the determined vehicle type.

15. The computer implemented method of claim 14, wherein one or more vehicle type identification signals associated with the vehicle include wireless communication signals associated with the vehicle or one or more devices within the vehicle.

16. The computer implemented method of claim 14, wherein the wireless communication signals include Bluetooth identification data.

17. The computer implemented method of claim 14, wherein the one or more vehicle type identification signals associated with the vehicle include a vehicle identification code provided by the vehicle.

18. The computer implemented method of claim 14, wherein the computing device further comprises an audio sensor and the one or more vehicle type identification signals include ambient sound data collected by the audio sensor.

19. The computer implemented method of claim 14, wherein the computing device further comprises a motion sensor and the one or more vehicle identification signals include motion data associated with movement of the vehicle.

20. A computer-readable medium storing instructions that, when executed by one or more computing devices, cause the one or more computing devices to perform operations, the operations comprising:
initiating, in response to user input, a navigation application;
detecting one or more vehicle type identification signals associated with a vehicle;
automatically determining, using the one or more signals, a vehicle type associated with the vehicle; and
receiving, from the navigation application, navigation information, wherein the navigation information is customized based on the determined vehicle type.
